(19) United States
(12) Patent Application Publication
(10) Pub. No.: US 2015/0121109 A1
(43) Pub. Date: Apr. 30, 2015

(54) VOLTAGE REGULATOR AND SEMICONDUCTOR MEMORY DEVICE INCLUDING THE SAME

(71) Applicant: Samsung Electronics Co., Ltd., Suwon-Si (KR)

(72) Inventors: Young-Hun SEO, Hwaseong-si (KR); Seung-Hoon OH, Yongin-si (KR); Kyu-Chan LEE, Seoul (KR)

(21) Appl. No.: 14/496,317

(22) Filed: Sep. 25, 2014

(30) Foreign Application Priority Data
Oct. 25, 2013 (KR) 10-2013-0127845

(51) Int. Cl. G06F 1/32

(52) U.S. Cl. CPC G06F 1/3296; G06F 1/3287
USPC 713/323

(57) ABSTRACT

one example embodiment, a voltage regulator includes a regulating unit configured to generate a cell array operating voltage based on a power supply voltage and a reference voltage, a power switch control unit configured to generate a power switch control signal based on a sensing enable signal, and a power switch unit configured to compensate for a drop in the cell array operating voltage based on the power supply voltage and the power switch control signal, the cell array operating voltage dropping when the sensing enable signal is activated.

### CROSS-REFERENCE TO RELATED APPLICATION

This application claims priority under 35 USC §119 to Korean Patent Application No. 2013-0127845, filed on Oct. 25, 2013 in the Korean Intellectual Property Office (KIPO), the contents of which are herein incorporated by reference in their entirety.

### BACKGROUND

1. Technical Field

Example embodiments relate generally to power supply, and more particularly to voltage regulators and semiconductor memory devices including the voltage regulators.

2. Description of the Related An

Typically, a semiconductor device includes a logic circuit performing a particular function and a power supply circuit for powering the logic circuit. For example, a semiconductor memory device may include a memory cell array storing data and a voltage regulator supplying a cell array operating voltage to the memory cell array, Recently, various technologies have been researched for stably supplying the cell array operating voltage to the memory cell array.

### SUMMARY

Accordingly, example embodiments of the inventive concepts are provided to address one or more problems due to limitations and disadvantages of the related art.

In one example embodiment, a voltage regulator includes a regulating unit configured to generate a cell array operating voltage based on a power supply voltage and a reference voltage. The voltage regulator further includes a power switch control unit configured to generate a power switch control signal based on a sensing enable signal and a power switch unit configured to compensate for a drop in the cell array operating voltage based on the power supply voltage and the power switch control signal the cell array operating voltage dropping when the sensing enable signal is activated.

In yet another example embodiment, the power switch unit includes a first power switch and a second power switch, and the power switch control signal includes a first power switch control signal and a second power switch control signal. The first and second power switches are simultaneously turned on in response to the first and second power switch control signals and sequentially turned off in response to the first and second power switch control signals.

In yet another example embodiment, the first and second power switch control signals are simultaneously activated based on the sensing enable signal, the first power switch control signal is deactivated after a first delay time elapses from a first time at which the first power switch control signal is activated, and the second power switch control signal is deactivated after a second delay time elapses from a second time at which the first power switch control signal is deactivated.

In yet another example embodiment, the first power switch includes a first electrode receiving the power supply voltage, a gate electrode receiving the first power switch control signal and a second electrode connected to a cell array operating voltage supply line outputting the cell array operating voltage. The second power switch includes a first electrode receiving the power supply voltage, a gate electrode receiving the second power switch control signal and a second electrode connected to the cell array operating voltage supply line.

In yet another example embodiment, the regulating unit and the power switch unit are independently controlled.

In yet another example embodiment, the power switch control unit includes a pulse signal generating unit configured to generate a pulse signal in response to the sensing enable signal, and a power switch control signal generating unit configured to generate the power switch control signal in response to the power supply voltage and the pulse signal,

In yet another example embodiment, the pulse signal generating unit includes a delay unit configured to delay the sensing enable signal and a NAND gate configured to generate the pulse signal by performing a NAND operation on the sensing enable signal and an output signal of the delay unit.

In yet another example embodiment, a pulse width of the pulse signal increases as a level of the power supply voltage is reduced.

In yet another example embodiment, the power switch control signal includes a first power switch control signal and a second power switch control signal and the power switch control signal generating unit includes a first AND gate configured to generate the first power switch control signal by performing an AND operation on the pulse signal and the power supply voltage. The power switch control signal generating unit further includes a delay unit configured to delay the first power switch control signal and a second AND gate configured to generate the second power switch control signal by performing the AND operation on the pulse signal and an output signal of the delay unit.

In yet another example embodiment, the power switch control unit includes a power switch control signal generating unit configured to generate the power switch control signal based on the sensing enable signal and a gate control signal. The power switch control unit further includes a comparator enabled in response to the sensing enable signal and configured to generate a comparison signal by comparing the cell array operating voltage with the reference voltage and a gate control signal generating unit configured to generate the gate control signal based on the sensing enable signal and the comparison signal.

In yet another example embodiment, the power switch control signal includes a first power switch control signal and a second power switch control signal, and the gate control signal includes a first gate control signal and a second gate control signal. The power switch control signal generating unit includes a first. AND gate configured to generate the first power switch control signal by performing an AND operation on the sensing enable signal and an inverted signal of the first gate control signal, and a second AND gate configured to generate the second power switch control signal by performing the AND operation on the sensing enable signal and an inverted signal of the second gate control signal.

In yet another example embodiment, the gate control signal generating unit includes a first delay unit configured to delay the sensing enable signal, third AND gate configured to generate a first signal by performing the AND operation on the comparison signal and an output signal of the first delay unit and a first flip-flop configured to generate the first gate control signal based on the power supply voltage and the first signal. The gate control signal generating unit further includes a second delay unit configured to delay the first gate control signal, a fourth AND gate configured to generate a second signal by performing the AND operation on the first signal and an output signal of the second delay unit and a second flip-flop configured to generate the second gate control signal based on the power supply voltage and the second signal.

In yet another example embodiment, an activation period of the first power switch control signal or an activation period of the second power switch control signal is adaptively adjusted based on a level of the cell array operating voltage.

In yet another example embodiment, the power switch unit includes a plurality of power switches that are divided into at least two power switch groups. The plurality of power switches are simultaneously turned on response to the power switch control signal and sequentially turned off per power switch group in response to the power switch control signal.

In one example embodiment, a semiconductor memory device includes a memory cell array including a plurality of memory cells, the memory cell array configured to operate based on a cell array operating voltage. The semiconductor memory device further includes a voltage regulator configured to generate the cell array operating voltage based on a power supply voltage. The voltage regulator includes a regulating unit configured to generate the cell array operating voltage based on the power supply voltage and a reference voltage. The voltage regulator further includes a power switch control unit configured to generate a power switch control signal based on a sensing enable signal and a power switch unit configured to compensate for a drop in the cell array operating voltage based on the power supply voltage and the power switch control signal, the cell array operating voltage dropping when the sensing enable signal is activated.

In yet another example embodiment, the power switches, from among the plurality of power switches, belonging to a first one of the at least two power switch groups is turned off before power switches, from among the plurality of power switches, belonging to a second one of the at least two power switch groups is turned off.

In one example embodiment, a voltage regulator includes a regulating circuit configured to generate a cell array operating voltage based on a power supply voltage and a reference voltage and a power switch control circuit configured to generate at least one power switch control signal based on a sensing enable signal. The voltage regulator further includes a power switch circuit configured to generate a current based on the power supply voltage and the at least one power switch control signal, and apply the current to a cell array operating voltage supply line outputting the generated cell array operating voltage.

In yet another example embodiment, the power switch control circuit is configured to activate the sensing enable signal, generate a pulse signal based on the activated sensing enable signal and activate a plurality of power switch control signals based on at least the generated pulse signal. The power switch control circuit is further configured to simultaneously activate a plurality of power switches in response to the activated plurality of power switch control signals and sequentially deactivate the plurality of power switches in response to deactivation of a corresponding one of the plurality of power switch control signals.

In yet another example embodiment, an amount of the generated current varies based on a number of the plurality of power switches that are active at a given time.

In yet another example embodiment, the amount of the generated current is directly proportional to the number of the plurality of power switches that are active at a given time.

### BRIEF DESCRIPTION OF THE DRAWINGS

Illustrative, non.-limiting example embodiments will be more clearly understood from the following detailed description taken in conjunction with the accompanying drawings.

FIG. I is a block diagram illustrating a voltage regulator, according to one example embodiment;

FIG. 2 is a diagram illustrating a configuration of a regulating unit included in the voltage regulator of FIG. 1, according to one example embodiment;

FIG. 3 is a diagram illustrating a configuration of a power switch control unit and a power switch unit included in the voltage regulator of FIG. 1, according to one example embodiment,

FIGS. 4, 5 and 6 are diagrams describing operations of the power switch control unit and the power switch unit of FIG. 3, according to one example embodiment;

FIG. 7 is a diagram illustrating an operational characteristic of a first delay unit included in the power switch control unit of FIG. 3, according to one example embodiment;

FIGS. 8A and 8B are diagrams illustrating another configuration of the power switch control unit and the power switch unit included in the voltage regulator of FIG. 1, according to one example embodiment;

FIGS. 9 and 10 are diagrams describing operations of the power switch control unit and the power switch unit of FIGS. 8A and 8B, according to one example embodiment;

FIG. 11 is a diagram illustrating another configuration of the power switch control unit and the power switch unit included in the voltage regulator of FIG. I, according to one example embodiment;

FIGS. 12, 13, 14 and 15 are diagrams describing operations of the power switch control unit and the power switch unit of FIG. 11, according to one example embodiment;

FIG. 16 is a diagram illustrating another configuration of the power switch control unit and the power switch unit included in the voltage regulator of FIG. 1, according to one example embodiment;

FIG. 17 is a Hock diagram illustrating a semiconductor memory device, according to one example embodiment;

FIG. 18 is a block diagram illustrating a memory module including the semiconductor memory device, according to one example embodiment; and

FIG. 19 is a block diagram illustrating a computing system including the semiconductor memory device, according to one example embodiment;

### DETAILED DESCRIPTION OF THE EXAMPLE EMBODIMENTS

Various example embodiments will be described more fully with reference to the accompanying drawings, in which the example embodiments are shown. The inventive concepts may, however, be embodied in many different forms and should not be construed as limited to the example embodiments set forth herein. Rather, these example embodiments are provided so that this disclosure will be thorough and complete, and will fully convey the scope of the inventive concepts to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or”” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a voltage regulator, according to one example embodiment.

Referring to FIG. 1, a voltage regulator 100 includes a regulating unit 200, a power switch control unit 300 and a power switch unit 400.

The regulating unit 200 generates a cell array operating voltage VINTA based on a power supply voltage VDD and a reference voltage VREFA. The cell array operating voltage VINTA may be output through a cell array operating voltage supply line VL and may be used for operating a memory cell array included in a semiconductor memory device. For example, a level of the cell array operating voltage VINTA may be lower than a level of the power supply voltage VDD.

The power switch control unit 300 generates a power switch control signal PS based on a sensing enable signal PPS. The power switch unit 400 compensates for a drop of the cell array's operating voltage VINTA (e.g., a voltage drop on the cell array operating voltage supply line VL) based on the power supply voltage VDD and the power switch control signal PS. In one example embodiment, the operating voltage VINTA of the cell array drops when the sensing enable signal PPS is activated.

In one example embodiment, the regulating unit 200 and the power switch unit 400 may be independently controlled. For example, the regulating unit 200 may maintain the level of the cell array operating voltage VINTA at a constant level by performing a feedback operation with respect to the cell array operating voltage VINTA. The power switch unit 400 may maintain the level of the cell array operating voltage VINTA at a constant level by providing an additional current to the cell array operating voltage supply line VL based on the power switch control signal PS. The power switch unit 400 may be controlled by the power switch control unit 300, and the regulating unit 200 may be controlled by itself or by another control unit (not illustrated).

The voltage regulator 100, according to one example embodiment, includes the power switch unit 400 that is controlled based on the power switch control signal PS. When the cell array's operating voltage VINTA is dropped (e.g., when the voltage on the cell array operating voltage supply line VL is dropped), the power switch unit 400 may provide additional current to the cell array operating voltage supply line VL based on the power switch control signal PS. Thus, the voltage regulator 100 may have a relatively high drivability, may effectively compensate for the voltage drop on the cell array operating voltage supply line VL, and may effectively supply stable power (e.g., a stable cell array operating voltage VINTA) to logic circuits included in the integrated circuit (e.g., the memory cell array included in the semiconductor memory device).

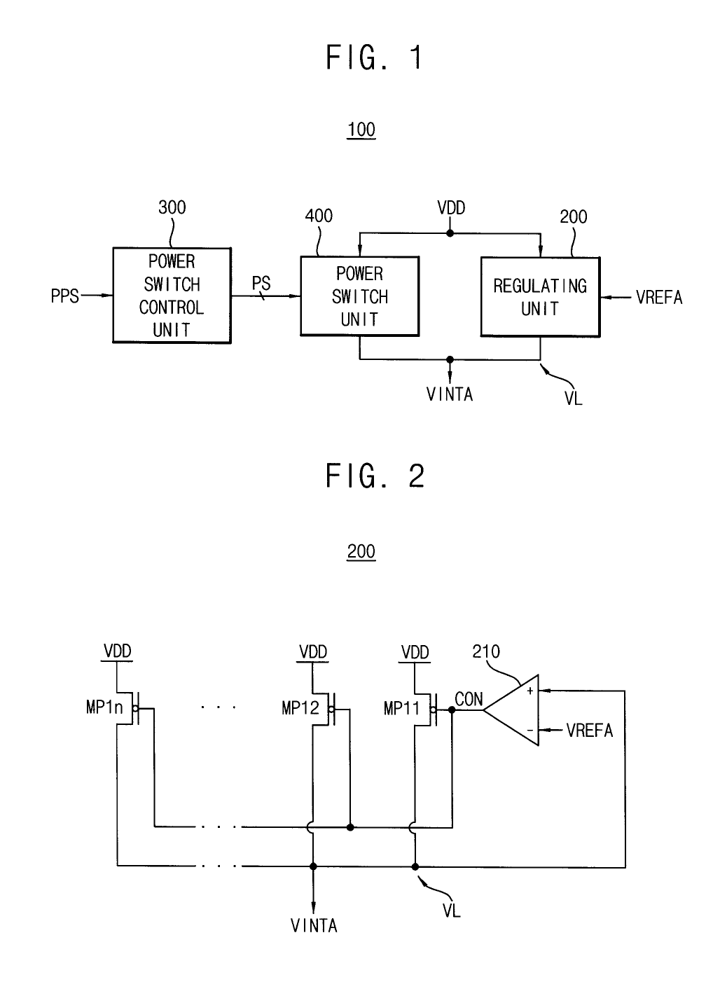

FIG. 2 is a diagram illustrating an example of a regulating unit included in the voltage regulator of FIG. 1,

Referring to FIG. 2, a voltage regulator 200 may include a plurality of transistors MP11, MP12, . . . , MP1n and a comparator 210.

The plurality of transistors MP11, . . . , MP1n may be p-type metal oxide semiconductor (PMOS) transistors. Each of the plurality of transistors MP11, . . . , MP1n may include a first electrode (e.g., a source electrode) receiving the power supply voltage VDD, a gate electrode receiving a control signal CON, and a second electrode (e.g., a drain electrode) connected to the cell array operating voltage supply line VL outputting the cell array operating voltage VINTA.

The comparator 210 may generate the control signal CON based on the cell array operating voltage VINTA and the reference signal VREFA. For example, the control signal CON may be activated when the level of the cell array operating voltage VINTA is higher than a level of the reference signal VREFA. The control signal CON may be deactivated when the level of the cell array operating voltage VINTA is equal to or lower than the level of the reference signal VREFA. Although FIG. 2 illustrates that the cell array operating voltage VINTA is directly provided as a feedback from the cell array operating voltage supply line VL to the comparator 210, the cell array operating voltage VINTA may be provided to a power supply network included in the memory cell array through the cell array operating voltage supply line VL, and thus the cell array operating voltage VINTA may be provided as a feedback from any point in the power supply network to the comparator 210.

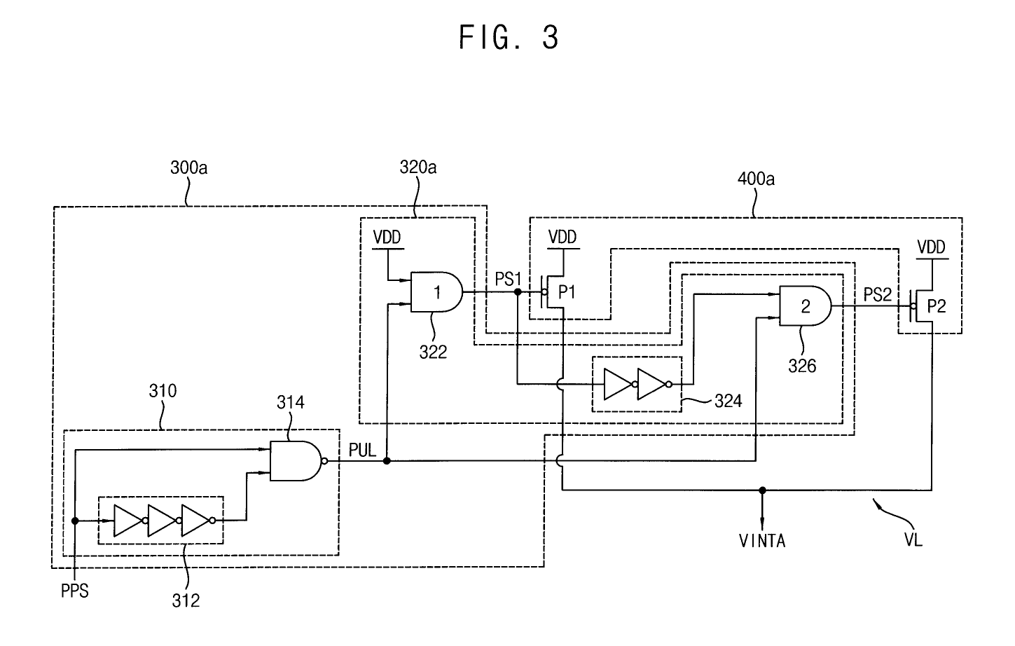

FIG. 3 is a diagram illustrating of a configuration of a power switch control unit and a power switch unit included in the voltage regulator of FIG. 1, according to one example embodiment.

Referring to FIG. 3, a power switch control unit 300a may generate the power switch control signal based on the sensing enable signal PPS. The power switch control signal may include a first power switch control signal PS1 and a second power switch control signal PS2. A power switch unit 400a may compensate for the drop of the cell array's operating voltage VINTA based on the power switch control signal.

The power switch unit 400a may include a first power switch P1 and a second power switch P2. The first and second power switches P1 and P2 may be simultaneously (e.g., concurrently) turned on in response to the first and second power switch control signals PS1 and PS2 and may be sequentially turned off in response to the first and second power switch control signals PS1 and PS2. For example, the first power switch P1 may be turned on and turned off in response to the first power switch control signal PS1. The second power switch P2 may be turned on and turned off in response to the second power switch control signal PS2. The second power switch P2 may be turned off after the first power switch P1 is turned off.

The first and second power switches P1 and P2 may be PMOS transistors. The first power switch P1 may include a first electrode receiving the power supply voltage VDD, a gate electrode receiving the first power switch control signal PS1, and a second electrode connected to the cell array operating voltage supply line VL outputting the cell array operating voltage VINTA. The second power switch P2 may include a first electrode receiving the power supply voltage VDD, a gate electrode receiving the second power switch control signal PS2, and a second electrode connected to the cell array operating voltage supply line VL.

The power switch control unit 300a may include a pulse signal generating unit 310 and a power switch control signal generating unit 320a. The pulse signal generating unit 310 may generate a pulse signal PIM in response to the sensing enable signal PPS. The power switch control signal generating unit 320a may generate the power switch control signal (e.g., the first and second power switch control signals PS1 and PS2) in response to the power supply voltage VDD and the pulse signal PUL.

The pulse signal generating unit 310 may include a first delay unit 312 and a NAND gate 314. The first delay unit 312 may delay the sensing enable signal PPS. For example, the first delay unit 312 may include a plurality of inverters that are cascade-connected. The NAND gate: 314 may generate the pulse signal PUL by performing a NAND operation on the sensing enable signal PPS and an output signal of the first delay unit 312 (e.g., the delayed sensing enable signal PPS),

in one example embodiment as will be described with reference to FIG. 7, a pulse width of the pulse signal PUL may be increased as a level of the power supply voltage VDD is reduced.

The power switch control signal generating unit 320a may include a first AND gate 322, a second delay unit 324 and a second AND gate 326. The first AND gate 322 may generate the first power switch control signal PS1 by performing an AND operation on the pulse signal PUL and the power supply voltage VDD. The second delay unit 324 may delay the first power switch control signal PS1. For example, the second delay unit 324 may include a plurality of inverters that are cascade-connected. The second AND gate 326 may generate the second power switch control signal PS2 by performing the AND operation on the pulse signal PUL and an output signal of the second delay unit 324 (e.g., the delayed first power switch control signal PS1).

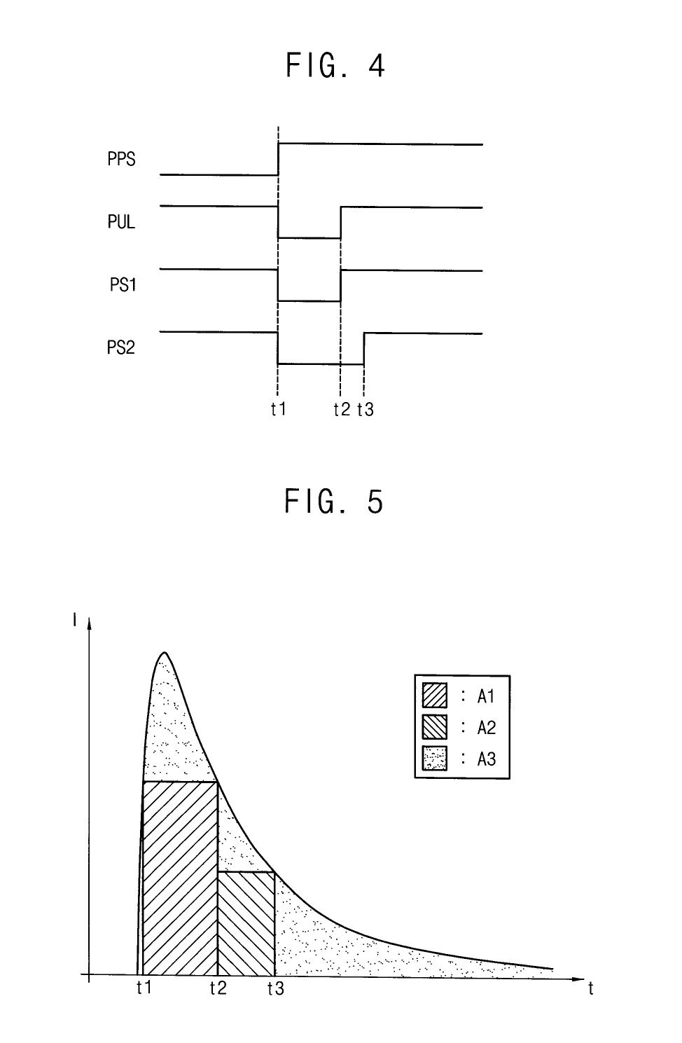

FIGS. 4, 5 and 6 are diagrams describing operations of the power switch control unit and the power switch unit of FIG. 3, according to one example embodiment.

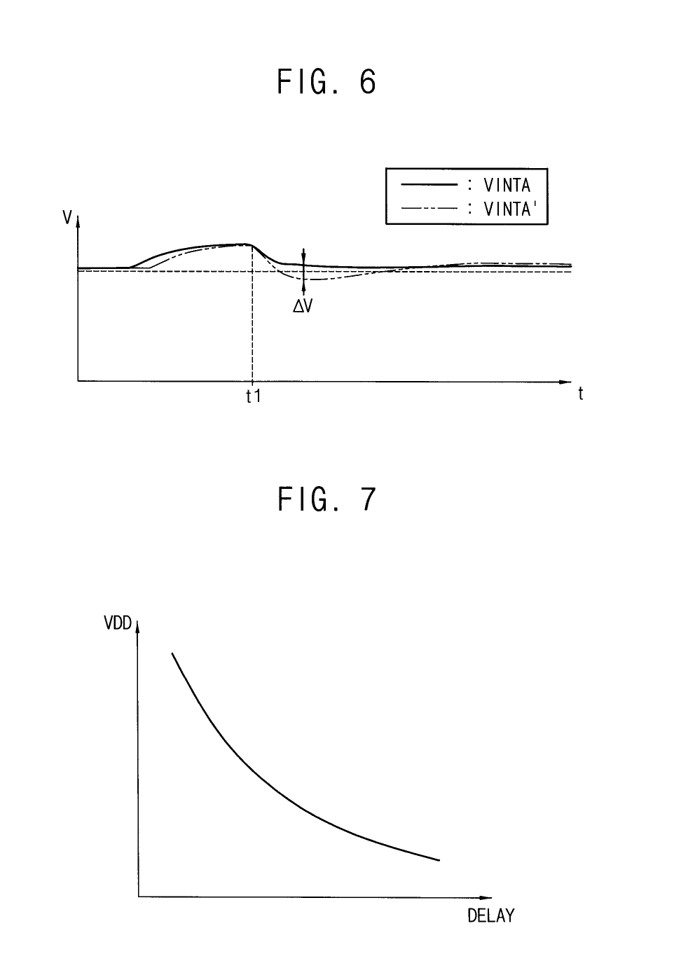

FIG. 4 is a timing diagram illustrating the operations of the power switch control unit and the power switch unit of FIG. 3, FIG. 5 is a graph illustrating the amount of current provided to the cell array operating voltage supply line VL. In FIG. 5, after the sensing enable signal PPS is activated, the current may be provided to the cell array operating voltage supply line VL for compensating for the drop of the cell array's operating voltage VINTA. FIG. 6 is a graph illustrating a variation of the cell array operating voltage with the lapse of time. In FIG. 6, VINTA indicates a variation of the cell array operating voltage in the voltage regulator with the power switch unit (e.g., the voltage regulator according to example embodiments), and VINTA′ indicates a variation of a cell array operating voltage in a voltage regulator without the power switch unit (e.g., a conventional voltage regulator),

Referring to FIGS. 3 and 4, at time t1, the sensing enable signal PPS is activated by transitioning from a logic low level to a logic high level. The pulse signal PUL is transitioned from the logic high level to the logic low level based on the activated sensing enable signal PPS. The first and second power switch control signals PS1 and PS2 are simultaneously activated by transitioning from the logic high level to the logic low level based on the activated sensing enable signal PPS. The first and second power switches P1 and P2 are simultaneously turned on in response to the activated first and second power switch control signals PS1 and PS2.

At time t2, which indicates a time point after a first delay time is elapsed from which the first and second power switch control signals PS1 and PS2 are simultaneously activated (e.g., from time t1), the pulse signal PUL is transitioned from the logic low level to the logic high level. The first power switch control signal PS1 is deactivated by transitioning from the logic low level to the logic high level based on the pulse signal PUL. The first power switch P1 is turned off in response to the deactivated first power switch control signal PS1. In an example of FIGS. 3 and 4, the first delay time may correspond to a delay of the first delay unit 312.

At time t3, which indicates a time point after a second delay time is elapsed from which the first power switch control signal PS1 is deactivated (e.g., from time t2), the second power switch control signal PS2 is deactivated by transitioning from the logic low level to the logic high level. The second power switch P2 is turned off in response to the deactivated second power switch control signal PS2. In an example of FIGS. 3 and 4, the second delay time may correspond to a delay of the second delay unit 324.

Referring to FIGS. 4 and 5, after the sensing enable signal PPS is activated (e.g., after time t1), the current may be provided to the cell array operating voltage supply line VL for compensating for the drop of the cell array's operating voltage VINTA. The current corresponding to first and second areas A1 and A2 may be provided by the power switch unit 400a, and the current corresponding to a third area A3 may be provided by the regulating unit 200 in FIG. 1. For example, during a period from time t1 to time t2, all of the first and second power switches P1 and P2 may be turned on, and thus a relatively high amount of current (e.g., the current corresponding to the first area A1) may be provided by the power switch unit 400a. During a period from time t2 to time t3, only the second power switch P2 may be turned on, and thus a relatively small amount of current (e.g., the current corresponding to the second area A2) may be provided by the power switch unit 400a. After time t3, all of the first and second power switches P1 and P2 may be turned off, and thus the current may only be provided by the regulating unit 200 in FIG. 1. As the power switch unit 400a provides the additional current to the cell array operating voltage supply line VL, the amount of current flowing through the regulating unit 200 in FIG. 1 may be reduced.

Referring to FIGS. 4 and 6, after the sensing enable signal PPS is activated (e.g., after time t1), the drop of the cell array's operating voltage may be reduced in the voltage regulator with the power switch unit. For example, in comparison with the drop of the cell array's operating voltage VINTA′ in the voltage regulator without the power switch unit (e.g., the conventional voltage regulator), the drop of the cell arrays operating voltage may be reduced by ΔV in the voltage regulator with the power switch unit (e.g., the voltage regulator according to example embodiments). For example, ΔV may be about 50 mV

FIG. 7 is a diagram illustrating an operational characteristic of a first delay unit included in the power switch control unit of FIG. 3, according to one example embodiment.

Referring to FIGS. 3 and 7, the first delay unit 312, may have an operational characteristic such that the delay of the first delay unit 312 is inversely proportional to the level of the power supply voltage VDD. Thus, the delay of the first delay unit 312 may be increased as the level of the power supply voltage VDD is reduced, and the pulse width of the pulse signal PUL (e.g., the period from time t1 to time t2 is a FIG. 4) may be increased as the delay of the first delay unit 312 is increased.

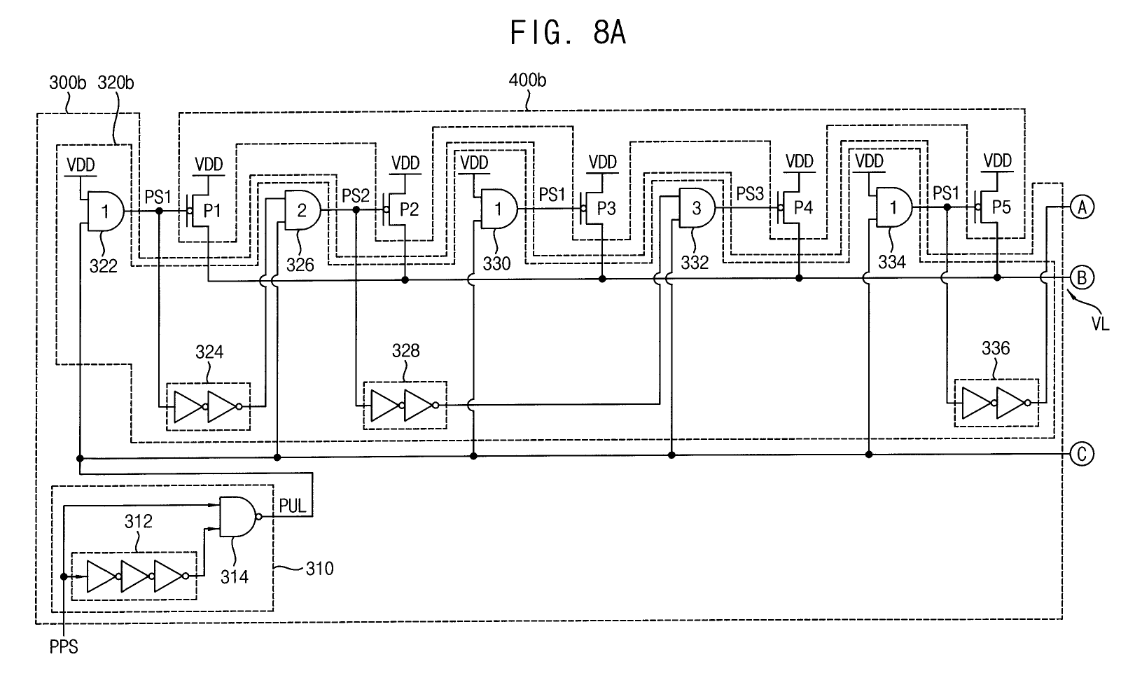

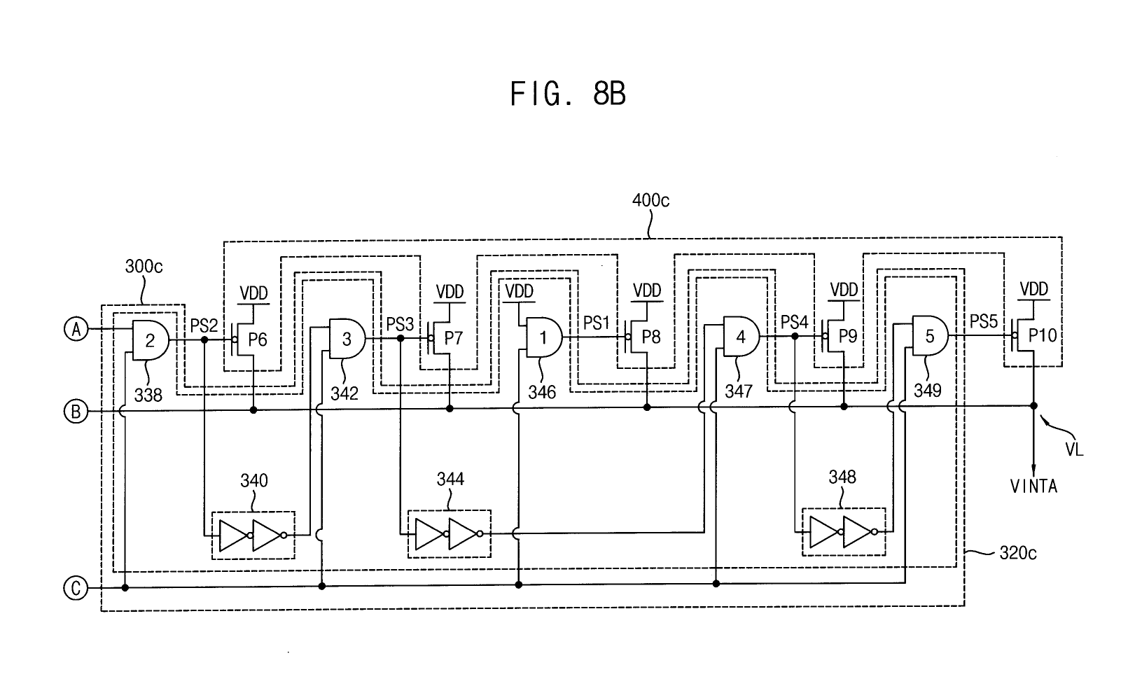

FIGS. 8A and 8B are diagrams illustrating another configuration of the power switch control unit and the power switch unit included in the voltage regulator of FIG. 1, according to one example embodiment.

Referring to FIGS. 8A and 8B, a power switch control unit 300b and 300c may generate the power switch control signal based on the sensing enable signal PPS. The power switch control signal may include a first power switch control signal PS1, a second power switch control signal PS2, a third power switch control signal PS3, a fourth power switch control signal PS4 and a fifth power switch control signal PS5. A power switch unit 400b and 400c may compensate for the drop of the cell array's operating voltage VINTA based on the power switch control signal.

The power switch unit 400b and 400c may include a plurality of power switches P1, P2, P3, P4, PS, P6, P7, P8, P9 and P10. The plurality of power switches P1, . . . , P10 may be divided into at least two power switch groups. For example, a first power switch group may include the power switches P1, P3, PS and P8. A second power switch group may include the power switches P2 and P6. A third power switch group may include the power switches P4 and P7. A fourth power switch group may include the power switch P9. A fifth power switch group may include the power switch P10.

The plurality of power switches P1, . . . , P10 may be simultaneously turned on in response to the first through fifth power switch control signals PS1, . . . , PS5 and may be sequentially turned off per power switch group in response to the first through fifth power switch control signals PS1, . . . , PS5. For example, the power switches P1, P3, PS and P8 included in the first power switch group may be turned on and turned off in response to the first power switch control signal PS1. The power switches P2 and P6 included in the second power switch group may be turned on and turned off in response to the second power switch control signal PS2. The power switches P4 and P7 included in the third power switch group may be turned on and turned off in response to the third power switch control signal PS3. The power switch P9 included in the fourth power switch group may be turned on and turned off in response to the fourth power switch control signal PS4. The power switch P 10 included in the fifth power switch group may be turned on and turned off in response to the fifth power switch control signal PS5. The power switches P2 and P6 included in the second power switch group may be turned off after the power switches P1, P3, PS and P8 included in the first power switch group are turned off. The power switches P4 and P7 included in the third power switch group may be turned off after the power switches P2 and P6 included in the second power switch group are turned off. The power switch P9 included in the fourth power switch group may be turned off after the power switches P4 and P7 included in the third power switch group are turned off. The power switch P10 included in the fifth power switch group may he turned off after the power switch P9 included in the fourth power switch group is turned off.

The plurality of power switches P1, . . . , P10 may be PMOS transistors. Each of the plurality of power switches P1, . . . , P10 may include a first electrode receiving the power supply voltage VDD, a gate electrode receiving a respective one of the first through fifth power switch control signals PS1, . . . , PS5, and a second electrode connected to the cell array operating voltage supply line VL outputting the cell array operating voltage VINTA.

The power switch control unit 300b and 300c may include a pulse signal generating unit 310 and a power switch control signal generating unit 320b and 320c , respectively.

The pulse signal generating unit 310 may generate a pulse signal PUL in response to the sensing enable signal PPS. The pulse signal generating unit 310 may include a first delay unit 312 and a NAND gate 314. The pulse signal generating unit 310 in FIG. 8A may be substantially the same as the pulse signal generating unit 310 in FIG. 3.

The power switch control signal generating unit. 320b and 320c may generate the power switch control signal (e.g., the first through the fifth power switch control signals PS1, . . . , PS5) in response to the power supply voltage VDD and the pulse signal PUL. The power switch control signal generating unit 320b and 320c may include AND gates 322, 326, 330, 332, 334, 338, 342, 346. 347 and 349, and delay units 324, 328, 336, 340, 344 and 348.

The AND gates 322, 330, 334 and 346 may generate the first power switch control signal PS1 by performing an AND operation on the pulse signal PUL and the power supply voltage VDD. The delay units 324 and 336 may delay the first power switch control signal PS1. The AND gates 326 and 338 may generate the second power switch control signal PS2 by performing the AND operation on the pulse signal PUL and an output signal of the delay units 324 and 336 (e.g., the delayed first power switch control signal PS1). The delay units 328 and 340 may delay the second power switch control signal P82. The AND gates 332 and 342 may generate the third power switch control signal PS3 by performing the AND operation on the pulse signal PUL and an output signal of the delay units 328 and 340 (e.g., the delayed second power switch control signal PS2). The delay unit 344 may delay the third power switch control signal PS3. The AND gate 347 may generate the fourth power switch control signal PS4 by performing the AND operation on the pulse signal PUL and an output signal of the delay unit 344 (e.g., the delayed third power switch control signal PS3). The delay unit 348 may delay the fourth power switch control signal PS4. The AND gate 349 may generate the fifth power switch control signal PS5 by performing the AND operation on the pulse signal PUL and an output signal of the delay unit 348 (e.g., the delayed fourth power switch control signal PS4).

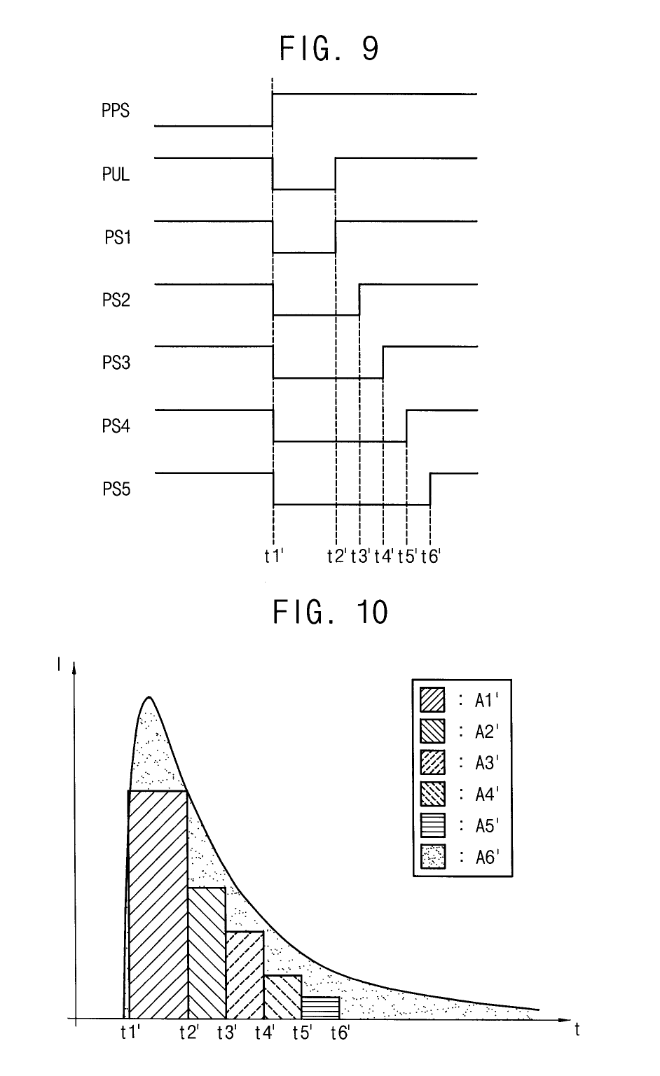

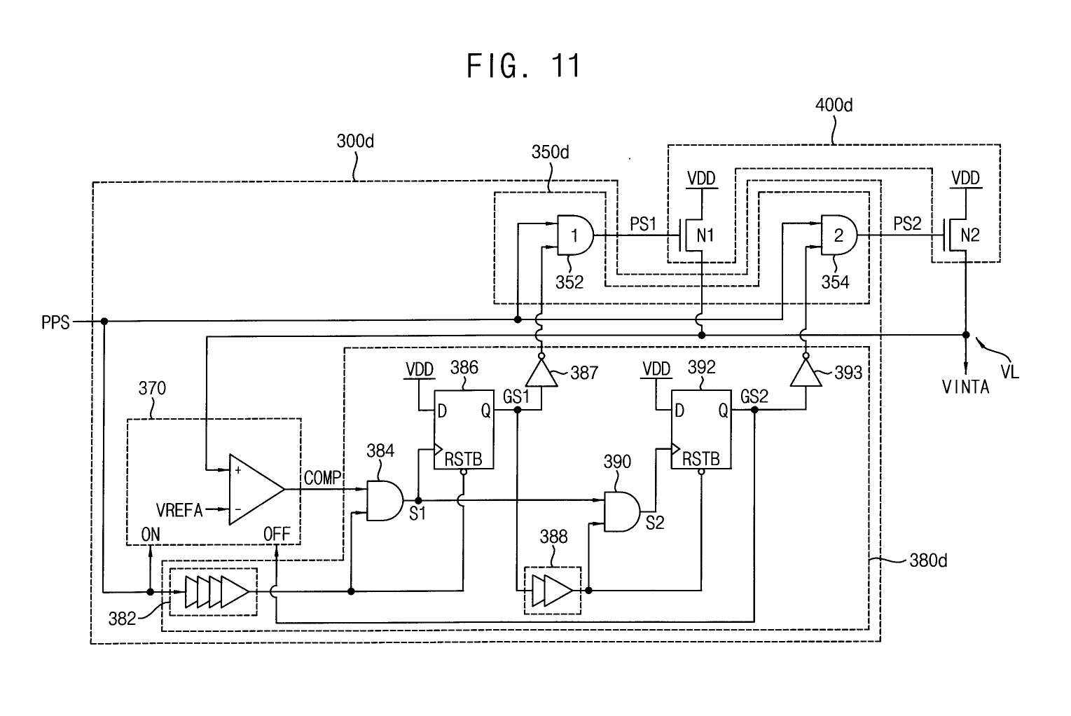

FIGS. 9 and 10 are diagrams describing operations of the power switch control unit and the power switch unit of FIGS. 8A and 8B, according to one example embodiment.

FIG. 9 is a timing diagram illustrating the operations of the power switch control unit and the power switch unit of FIGS. 8A and 8B. FIG. 10 is a graph illustrating the amount of current provided to the cell array operating voltage supply line VL. In FIG. 10, after the sensing enable signal PPS is activated, the current may be provided to the cell array operating voltage supply line VL for compensating for the drop of the cell array's operating voltage VINTA.

Referring to FIGS. 8A, 8B and 9, at time t1′, the sensing enable signal PPS is activated by transitioning from a logic low level to a logic high level. The pulse signal PUL is transitioned from the logic high level to the logic low level based on the activated sensing enable signal PPS. The first through fifth power switch control signals PS1, . . . , PS5 are simultaneously activated by transitioning from the logic high level to the logic low level based on the activated sensing enable signal PPS. The plurality of power switches P1, . . . , P10 are simultaneously turned on in response to the activated first through fifth power switch control signals PS1, . . . , PS5.

At time t2′, the pulse signal PUL is transitioned from the logic low level to the logic high level. The first power switch control signal PS1 is deactivated by transitioning from the logic low level to the logic high level based on the pulse signal PUL. The power switches P1, P3, PS and PS included in the first power switch group are turned off in response to the deactivated first power switch control signal PS1.

At time t3′, the second power switch control signal PS2 is deactivated by transitioning from the logic low level to the logic high level. The power switches P2 and P6 included in the second power switch group are turned off in response to the deactivated second power switch control signal PS2.

At time t4′, the third power switch control signal PS3 is deactivated by transitioning from the logic low level to the logic high level. The power switches P4 and P7 included in the third power switch group are turned off in response to the deactivated third power switch control signal PS3,

At time t5′ the fourth power switch control signal PS4 is deactivated by transitioning from the logic low level to the logic high level. The power switch P9 included in the fourth power switch group are turned off in response to the deactivated fourth power switch control signal PS4.

At time t6′, the fifth power switch control signal PS5 is deactivated by transitioning from the logic low level to the logic high level. The power switch P10 included in the fifth power switch group are turned of in response to the deactivated fifth power switch control signal PS5.

Referring to FIGS. 9 and 10, after the sensing enable signal PPS is activated (e.g., after time t1′), the current may be provided to the cell array operating voltage supply line VL for compensating for the drop of the cell array's operating voltage VINTA. The current corresponding to first through fifth areas A1′, A2′, A3′, A4′ and A5′ may be provided by the power switch unit 400b and 400c, and the current corresponding to a sixth area A6′ may be provided by the regulating unit 200 in FIG. 1. For example, during a period from time t1′ to time t2′, all of the power switches P1, . . . , P10 may he turned on, and thus a relatively great amount of current (e.g., the current corresponding to the first area A1′) may be provided by the power switch unit 400b and 400c. During a period from time t5′ to time t6′, only the power switch P10 may be turned on, and thus a relatively small amount of current (e.g., the current corresponding to the fifth area A5′) may be provided by the power switch unit 400b and 400c.

FIG. 11 is a diagram illustrating still another example of the power switch control unit and the power switch unit included in the voltage regulator of FIG. 1.

Referring to FIG. 11, a power switch control unit 300d may generate the power switch control signal based on the sensing enable signal PPS. The power switch control signal may include a first power switch control signal PS1 and a second powers witch control signal PS2. A power switch unit 400d may compensate for the drop of the cell array's operating voltage VINTA based on the power switch control signal.

The power switch unit 400d may include a first power switch N1 and a second power switch N2. The first and second power switches N1 and N2 may be simultaneously turned on in response to the first and second power switch control signals PS1 and PS2 and may be sequentially turned off in response to the first and second power switch control signals PS1 and PS2. The first and second power switches N1 and N2 may he n-type metal oxide semiconductor (NMOS) transistors. Each of the first and second power switches N1 and N2 may include a first electrode receiving the power supply voltage VDD, a gate electrode receiving a respective one of the first and second power switch control signals PS1 and PS2, and a second electrode connected to the cell array operating voltage supply line VL outputting the cell array operating voltage VINTA.

The power switch control unit 300d may include a power switch control signal generating unit 350d, a comparator 370 and a gate control signal generating unit 380d. The power switch control signal generating unit 350d may generate the power switch control signal (e.g., the first and second power switch control signals PS1 and PS2) based on the sensing enable signal PPS and a gate control signal. The gate control signal may include a first gate control signal GS1 and a second gate control signal GS2. The comparator 370 may be enabled in response to the sensing enable signal PPS. The comparator 370 may be disabled in response to the second gate control signal GS2. The comparator 370 may generate a comparison signal COMP by comparing the cell array operating voltage VINTA with the reference voltage VREFA. The gate control signal generating unit 380d may generate the gate control signal (e,g., the first and second gate control signals GS1 and GS2) based on the sensing enable signal PPS and the comparison signal COMP.

The power switch control signal generating unit 350d may include a first AND gate 352 and a second AND gate 354. The first AND gate 352 may generate the first power switch control signal PS1 by performing an AND operation on the sensing enable signal PPS and an inverted signal of the first gate control signal GS1. The second AND gate 354 may generate the second power switch control signal PS2 by performing the AND operation on the sensing enable signal PPS and an inverted signal of the second gate control signal GS2.

The gate control signal generating unit 380d may include a first delay unit 382, a third AND gate 384, a first flip-flop 386, a second delay unit 388, a fourth AND gate 390 and a second flip-flop 392. The gate control signal generating unit 380d may further include a first inverter 387 and a second inverter 393.

The first delay unit 382 may delay the sensing enable signal PPS. The third AND gate 384 may generate a first signal S1 by performing the AND operation on the comparison signal COMP and an output signal of the first delay unit 382 (e.g., the delayed sensing enable signal PPS). The first flip-flop 386 may generate the first gate control signal GS1 based on the power supply voltage VDD and the first signal S1. The first flip-flop 386 may include a data input terminal receiving the power supply voltage VDD, a clock input terminal receiving the first signal S1, a reset terminal receiving the output signal of the first delay unit 382 and a data output terminal outputting; the first gate control signal GS1. The first inverter 387 may invert the first gate control signal GS1.

The second delay unit 388 may delay the first gate control signal GS1. The fourth AND gate 390 may generate a second signal S2 by performing the AND operation on the first signal S1 and an output signal of the second delay unit 388 (e.g., the delayed first gate control signal GS1). The second flip-flop 392 may generate the second gate control signal GS2 based on the power supply voltage VDD and the second signal 82. The second flip-flop 392 may include a data input terminal receiving the power supply voltage VDD, a clock input terminal receiving the second signal S2, a reset terminal receiving the output signal of the second delay unit 388 and a data output terminal outputting the second gate control signal GS2. The second inverter 393 may invert the second gate control signal GS2.

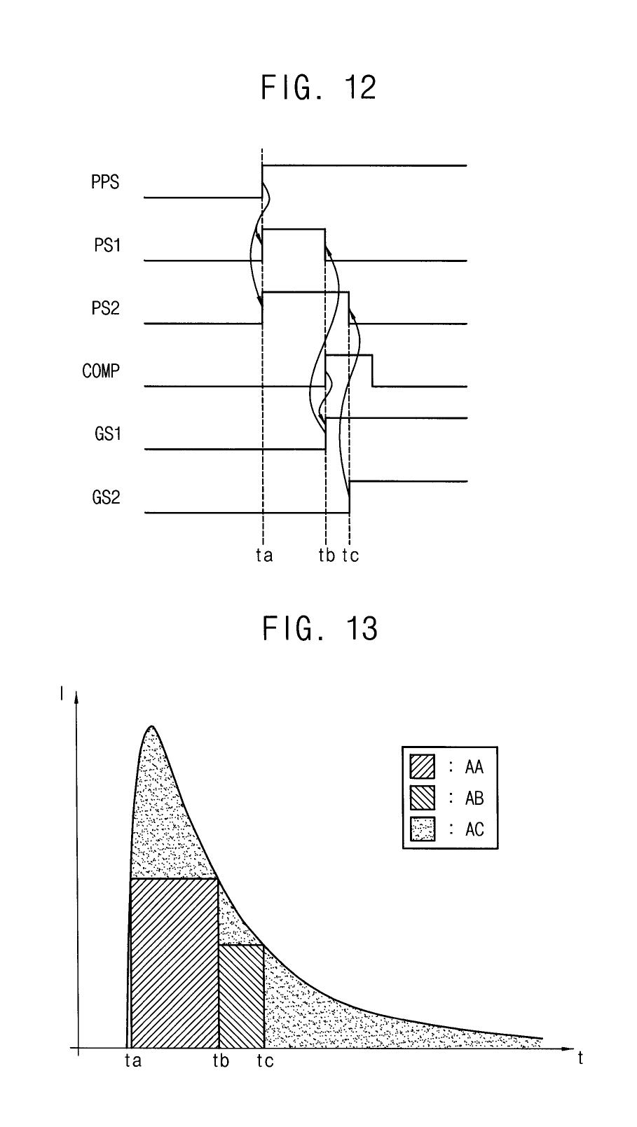

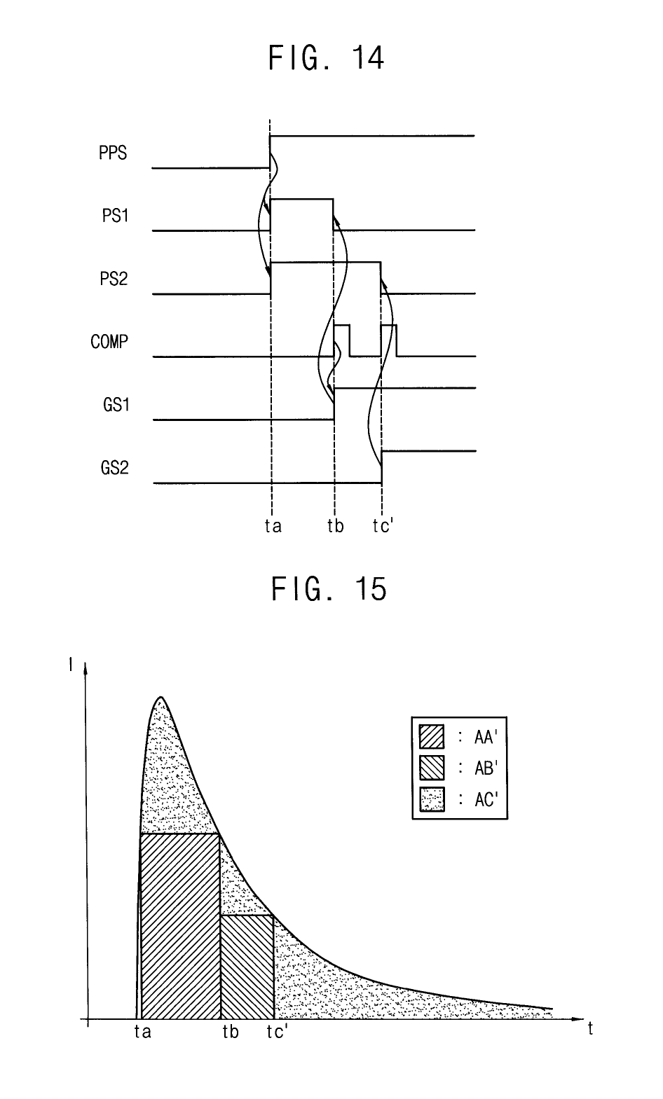

In one example embodiment, as will be described with reference to FIGS. 12 and 14, an activation period of the first power switch control signal PS1 or an activation period of the second power switch control signal PS2 may be adaptively adjusted based on the level of the cell array operating voltage VINTA.

FIGS. 12, 13, 14 and 15 are diagrams describing operations of the power switch control unit and the power switch unit of FIG. 11, according to one example embodiment.

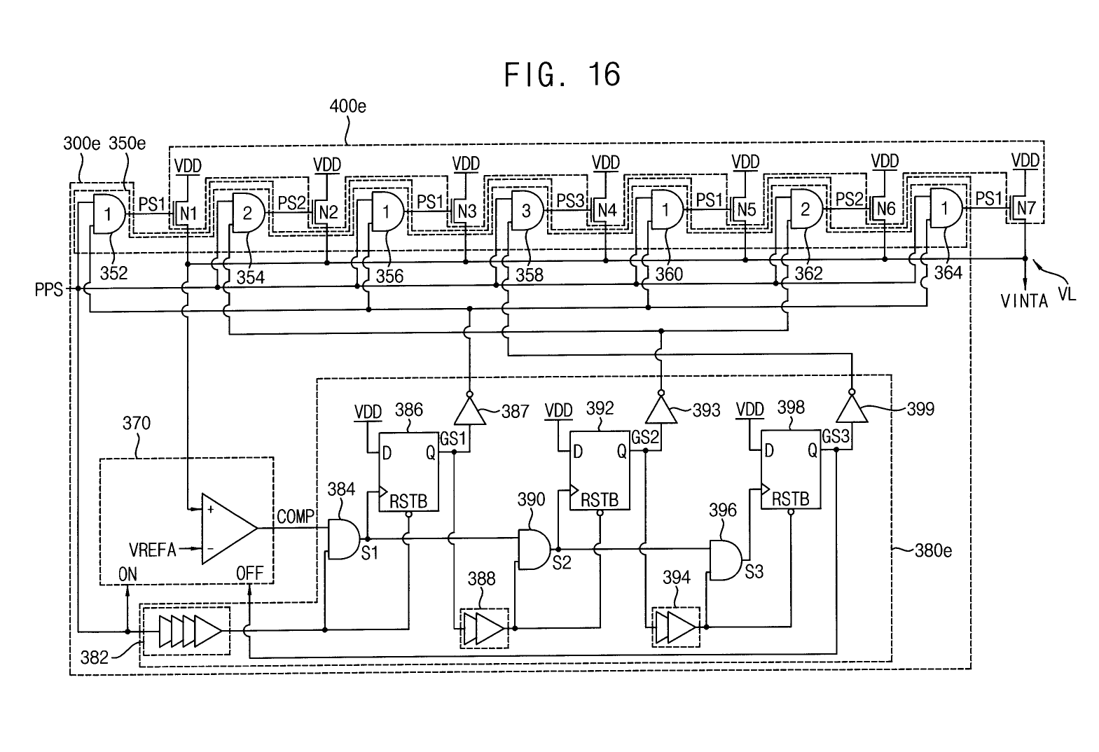

FIG. 12 is a timing diagram illustrating an example of the operations of the power switch control unit and the power switch unit of FIG. 11. FIG. 13 is a graph illustrating the amount of current provided to the cell array operating voltage supply line VL when the power switch control unit and the power switch unit of FIG. 11 operate based on the timing diagram of FIG. 12. FIG. 14 is a timing diagram illustrating another example of the operations of the power switch control unit and the power switch unit of FIG. 11. FIG. 15 is a graph illustrating the amount of current provided to the cell array operating voltage supply line VL when the power switch control unit and the power switch unit of FIG. 11 operate based on the timing diagram of FIG. 14,

Referring to FIGS. 11 and 12, at time ta, the sensing enable signal PPS is activated by transitioning from a logic low level to a logic high level. The first and second power switch control signals PS1 and PS2 are simultaneously activated by transitioning from the logic low level to the logic high level based on the activated sensing enable signal PPS. The first and second power switches N1 and N2 are simultaneously turned on in response to the activated first and second power switch control signals PS1 and PS2.

The comparison signal COW may be activated when the level of the cell array operating voltage VINTA is higher than the level of the reference signal VREFA. The comparison signal COMP may be deactivated when the level of the cell array operating voltage VINTA is equal to or lower than the level of the reference signal VREFA.

After time ta, an additional current is provided to the cell array operating voltage supply VL based on the turned-on first and second power switches N1 and N2. At time tb, the level of the cell array operating voltage VINTA becomes higher than the level of the reference signal VREFA, and then comparison signal COMP is activated by transitioning from the logic low level to the logic high level. The first gate control signal GS1 is activated by transitioning from the logic low level to the logic high level based on the activated comparison signal COMP. The first power switch control signal PS1 is deactivated by transitioning from the logic high level to the logic low level based on the activated first gate control signal GS1. The first power switch N1 is turned off in response to the deactivated first power switch control signal PS1.

After time tb, although the first power switch N1 is turned of the level of the cell array operating voltage VINTA may be still higher than the level of the reference signal VREFA and the comparison signal COMP may be still activated. In this case, at time tc, the second gate control signal GS2 is activated by transitioning from the logic low level to the logic high level based on the activated comparison signal COMP. The second power switch control signal PS2 is deactivated by transitioning from the logic high level to the logic low level based on the activated second gate control signal GS2. The second power switch N2 is turned off in response to the deactivated second power switch control signal PS2. In an example of FIGS. 11 and 12, a delay time between time th and time tc may correspond to a delay of the second delay unit 388. After time tc, the comparator 370 is disabled in response to the activated second gate control signal GS2, and then the comparison signal COMP is deactivated by transitioning from the logic high level to the logic low level.

Referring to FIGS. 12 and 13, after the sensing enable signal PPS is activated (e,g., after time ta), the current may be provided to the cell array operating voltage supply line VL for compensating for the drop of the cell array's operating voltage VINTA. The current corresponding to first and second areas AA and AB may be provided by the power switch unit 400d, and the current corresponding to a third area AC may be provided by the regulating unit 200 in FIG. 1.

Referring to FIGS. 11 and 14, the operations of the power switch control unit and the power switch unit during a period from time ta to time th in FIG. 14 may be substantially the same as the operations of the power switch control unit and the power switch unit during the period from time ta to time tb ire FIG. 12.

After time tb, since the first power switch N1 is turned off, the level of the cell array operating voltage VINTA may become lower than the level of the reference signal VREFA and the comparison signal COMP may be deactivated by transitioning from the logic high level to the logic low level. However, an additional current is still provided to the cell array operating voltage supply line VL based on the turned-on second power switch N2, and then, at time tc', the level of the cell array operating voltage VINTA becomes higher than the level of the reference signal VREFA again and then comparison signal COMP is activated by transitioning from the logic low level to the logic high level. In this case, at time tc′, the second gate control signal GS2 is activated by transitioning from the logic low level to the logic high level based on the activated comparison signal COMP The second power switch control signal PS2 is deactivated by transitioning from the logic high level to the logic low level based on the activated second gate control signal GS2. The second power switch N2 is turned off in response to the deactivated second power switch control signal PS2. In an example of FIGS. 11 and 14, a delay time between time tb and time tc′ in FIG. 14 may be longer than the delay time between time tb and time tc in FIG. 12. After time tc′, the comparator 370 is disabled in response to the activated second gate control signal GS2, and then the comparison signal COMP is deactivated by transitioning from the logic high level to the logic low level.

Referring to FIGS. 14 and 15, after the sensing enable signal PPS is activated (e,g., after time ta), the current may be provided to the cell array operating voltage supply line VL for compensating for the drop of the cell array's operating voltage VINTA. The current corresponding to first and second areas AA′ and AB′ may be provided by the power switch unit 400d, and the current corresponding to a third area AC′ may be provided by the regulating unit 200 in FIG. 1.

Although FIGS. 12 and 14 illustrate that the activation period of the second power switch control signal PS2 is adaptively adjusted based on the level of the cell array operating voltage VINTA, the activation period of the first power switch control signal PS1 may be adaptively adjusted based on the level of the cell array operating voltage VINTA.

FIG. 16 is a diagram illustrating another configuration of the power switch control unit and the power switch unit included in the voltage regulator of FIG. 1, according to one example embodiment.

Referring to FIG. 16, a power switch control unit 300e may generate the power switch control signal based on the sensing enable signal PPS. The power switch control signal may include a first power switch control signal PS1, a second power switch control signal PS2 and a third power switch control signal PS3. A power switch unit 400e may compensate for the drop of the cell array's operating voltage VINTA based on the power switch control signal.

The power switch unit 400e may include a plurality of power switches N1, N2, N3, N4, N5, N6 and N7. The plurality of power switches N1, . . . , N7 may be divided into at least two power switch groups. For example, a first power switch group may include the power switches N1, N3, N5 and N7. A second power switch group may include the power switches N2 and N6. A third power switch group may include the power switch N4, The plurality of power switches N1, . . . , N7 may be simultaneously turned on in response to the first through third power switch control signals PS1, . . . , PS3 and may be sequentially turned off per power switch group in response to the first through third power switch control signals PS1, . . . , PS3. The plurality of power switches N1, . . . , N7 may be NMOS transistors. Each of the plurality of power switches N1, . . . , N7 may include a first electrode receiving the power supply voltage VDD, a pate electrode receiving a respective one of the first through third power switch control signals PS1, . . . , PS3, and a second electrode connected to the cell array operating voltage supply line VL outputting the cell array operating voltage VINTA.

The power switch control unit 300e may include a power switch control signal generating unit 350e, a comparator 370 and a gate control signal generating unit 380e. The power switch control signal generating unit 350e may generate the power switch control signal (e.g., the first through third power switch control signals PS1, . . . , PS3) based on the sensing enable signal PPS and a gate control signal. The gate control signal may include a first gate control signal GS1, a second gate control signal GS2 and a third gate control signal GS3. The comparator 370 may be enabled in response to the sensing enable signal PPS. The comparator 370 may be disabled in response to the third gate control signal GS3. The comparator 370 may generate a comparison signal COMP by comparing the cell array operating voltage VINTA with the reference voltage VREFA. The gate control signal generating unit 380e may generate the gate control signal (e.g., the first through third gate control signals GS1, . . . , GS3) based on the sensing enable signal PPS and the comparison signal COMP.

The power switch control signal generating unit 350e may include AND gates 352, 354, 356, 358, 360, 362 and 364. The AND gates 352, 356. 360 and 364 may generate the first power switch control signal PS1 by performing an AND operation on the sensing enable signal PPS and an inverted signal of the first gate control signal GS1. The AND gates 354 and 362 may generate the second power switch control signal PS2 by performing the AND operation on the sensing enable signal PPS and an inverted signal of the second gate control signal GS2. The AND gate 338 may generate the third power switch control signal PS3 by performing the AND operation on the sensing enable signal PPS and an inverted signal of the third gate control signal GS3.

The gate control signal generating unit 380e may include delay units 382, 388 and 394, AND gates 384, 390 and 396, and flip-flops 386, 392 and 398. The gate control signal generating unit 380e may further include inverters 387, 393 and 399.

The delay units 382 and 388, the AND gates 384 and 390, the flip-flops 386 and 392, and the inverters 387 and 393 in FIG. 16 may be substantially the same as the delay units 382 and 388, the AND gates 384 and 390, the flip-flops 386 and 392, and the inverters 387 and 393 in FIG. 11, respectively. The delay unit 394 may delay the second gate control signal GS2. The AND gate 396 may generate a third signal 53 by performing the AND operation on the second signal S2 and an output signal of he delay unit 394 (e.g., the delayed second gate control signal GS2). The flip-flop 398 may generate the third gate control signal GS3 based on the power supply voltage VDD and the third signal S3. The flip-flop 398 may include a data input terminal receiving the power supply voltage VDD, a clock input terminal receiving the third signal S3, a reset terminal receiving the output signal of the delay unit 394 and a data output terminal outputting the third gate control signal 0S3. The inverter 399 may invert the third gate control signal GS3,

The power switch control unit 300e and the power switch unit 400e of FIG. 16 may operate similarly to examples described above with reference to FIGS. 12 and 14.

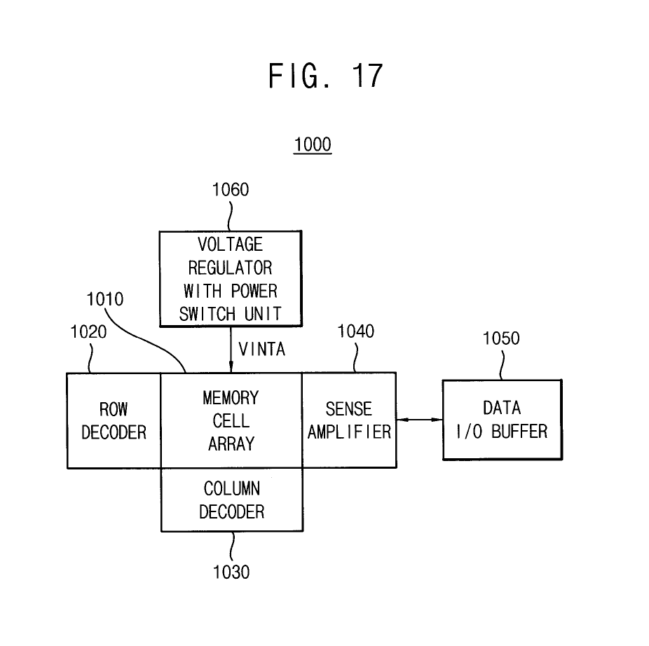

FIG. 17 is a block diagram illustrating a semiconductor memory device, according to one example embodiment.

Referring to FIG. 17, a semiconductor memory device 1000 includes a memory cell array 1010 and a voltage regulator 1060. The semiconductor memory device 1000 may further include a row decoder 1020, a column decoder 1030, a sense amplifier 1040 and a data input/output (I/O) buffer 1050.

The memory cell array 1010 includes a plurality of memory cells that store data. Each of the plurality of memory cells may be connected to a respective one of a plurality of wordlines and a respective one of a plurality of bitlines. The memory cell array 1010 operates based on a cell array operating voltage VINTA.

The row decoder 1020 may select one of the plurality of wordlines of the memory cell array 1010 by decoding a row address. The column decoder 1030 may select at least one of the plurality of bitlines of the memory cell array 1010 by decoding a column address. The sense amplifier 1040 may generate read data by sensing data stored in the selected memory cells or may store write data received from a memory controller (not illustrated) into the selected memory cells. The data 110 buffer 1050 may provide the read data to the memory controller or may provide the write data to the sense amplifier 1040.

The voltage regulator 1060 generates the cell array operating voltage VINTA based on a power supply voltage and a sensing enable signal. The voltage regulator 1060 may be the voltage regulator 100 of FIG. 1. The voltage regulator 1060 may include a power switch unit that provides an additional current to a cell array operating voltage supply line outputting the cell array operating voltage VINTA when an operating voltage VINTA of the cell array is dropped (e.g., when the voltage on the cell array operating voltage supply line is dropped). Thus, the voltage regulator 1060 may effectively compensate for the voltage drop on the cell array operating voltage supply line and may effectively supply the stable cell array operating voltage VINTA to the memory cell array 1010. The semiconductor memory device 1000 including the voltage regulator 1060 may have a relatively stable operational characteristic and a relatively high operating speed.

Although not illustrated in FIG. 17, the semiconductor memory device 1000 may further include an address butler that provides the row address and the column address to the row decoder 1020 and the column decoder 1030 based on an address signal received from the memory controller.

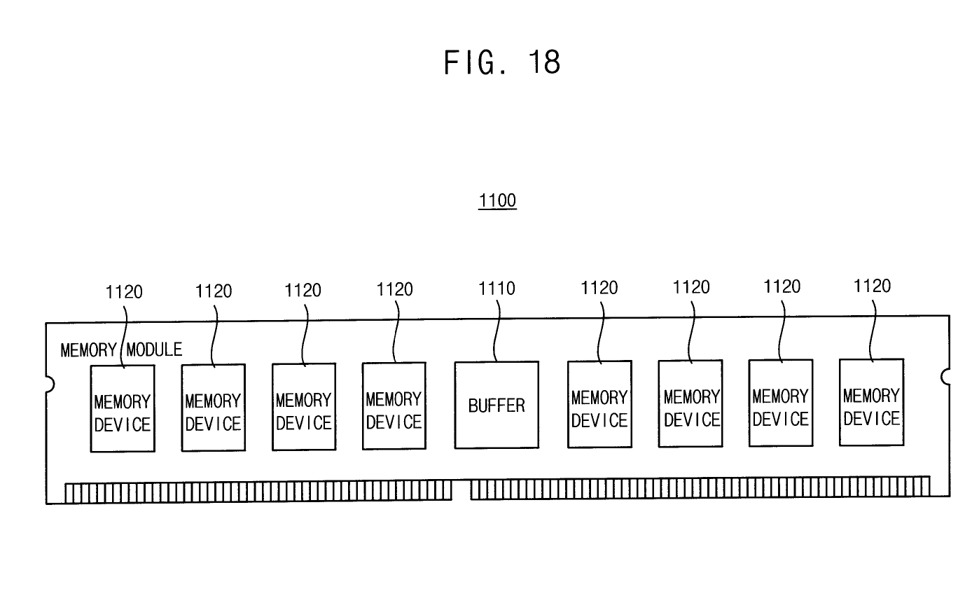

FIG. 18 is a block diagram illustrating a memory module including the semiconductor memory device, according to one example embodiment.

Referring to FIG. 18, a memory module 1100 may include a plurality of semiconductor memory devices 1120. According to one example embodiment, the memory module 1100 may be an unbuffered dual in-line memory module (UDIMM), a registered dual in-line memory module (RDIMM), a fully buffered dual in-line memory module (FBDIMM), a load reduced dual in-line memory module (LRDIMM), etc.

The memory module 1100 may further include a buffer 1110. The buffer 1110 may receive a command signal, an address signal and/or data from a memory controller (not illustrated) through a plurality of transmission lines, and may provide the command signal, the address signal and/or the data to the plurality of semiconductor memory devices 1120 by buffering the command signal, the address signal and/or the data.

In an example embodiment, data transmission lines between the buffer 1110 and the semiconductor memory devices 1120 may be connected in a point-to-point topology. In an example embodiment, command/address transmission lines between the buffer 1110 and the semiconductor memory devices 1120 may be connected in a multi-drop topology, a daisy-chain topology, a fly-by daisy-chain topology, or the like. Since the buffer 1110 buffers all of the command signal, the address signal and the data, the memory controller may interface with the memory module 1100 by driving only a load of the buffer 1110. Accordingly, the memory module 1100 may include more semiconductor memory devices 1120 and/or more memory ranks, and a memory system may include more memory modules.

Each of the semiconductor memory devices 1120 may be the semiconductor memory devices 1000 of FIG. 17. Each of the semiconductor memory devices 1120 may include a power switch unit that provides an additional current to a cell array operating voltage supply line outputting a cell array operating voltage when an operating voltage of the cell array is dropped (e.g., when the voltage on the cell array operating voltage supply line is dropped). Thus, the semiconductor memory devices 1120 including the voltage regulator may have a relatively stable operational characteristic and a relatively high operating speed.

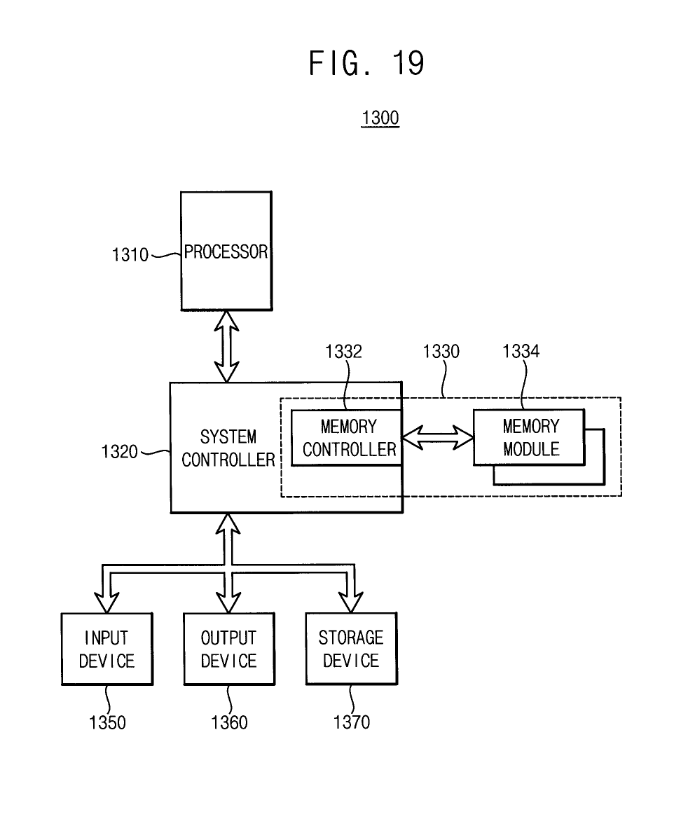

FIG. 19 is a block diagram illustrating a computing system including the semiconductor memory device, according to one example embodiment.

Referring to FIG. 19, a computing system 1300 may include a processor 1310, a system controller 1320 and a memory system 1.330. The computing system 1300 may further include an input device 1350, an output device 1360 and a storage device 1370.

The memory system 1330 may include a plurality of memory modules 1334, and a memory controller 1332 for controlling the memory modules 1334. The memory modules 1334 may include a plurality of semiconductor memory devices. According to example embodiments, each of the semiconductor memory devices may include at least one volatile memory, such as a dynamic random access memory (DRAM), a static random access memory (SRAM), and/or at least one nonvolatile memory, such as an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), a polymer random access memory (PoRAM). The memory controller 1332 may be included in the system controller 1320.

Each of the memory modules 1334 may be the memory module 1100 of FIG. 18. Each of the semiconductor memory devices included in each of the memory modules 1334 may include a power switch unit that provides an additional current to a cell array operating voltage supply line outputting a cell array operating voltage when an operating voltage of the cell array is dropped (e.g., when the voltage on the cell array operating voltage supply line is dropped). Thus, the semiconductor memory devices including the voltage regulator and the memory modules 1334 may have a relatively stable operational characteristic and a relatively high operating speed.

The processor 1310 may perform various computing functions, such as executing specific software for performing specific calculations or tasks. The processor 1310 may he connected to the system controller 1320 via a processor bus. The system controller 1320 may be connected to the input device 1350, the output device 1360 and the storage device 1370 via an expansion bus. As such, the processor 1310 may control the input device 1350, the output device 1360 and the storage device 1370 using the system controller 1320.

The above described embodiments may be used in a semiconductor memory device or system including the semiconductor memory device, such as a mobile phone, a smart phone, a personal digital assistants (PDA), a portable multimedia player (PMP), a digital camera, a digital television, a set-top box, a music player, a portable game console, a navigation device, a personal computer (PC), a server computer, a workstation,a tablet computer, a laptop computer, a smart card, a printer, etc.

The foregoing is illustrative of example embodiments and is not to be construed as limiting thereof Although a few example embodiments have been described, those skilled in the art will readily appreciate that many modifications are possible in the example embodiments without materially departing from the novel teachings and advantages of the inventive concepts. Accordingly, all such modifications are intended to be included within the scope of the inventive concepts as defined in the claims. Therefore, it is to be understood that the foregoing is illustrative of various example embodiments and is not to he construed as limited to the specific example embodiments disclosed, and that modifications to the disclosed example embodiments, as well as other example embodiments, are intended to be included within the scope of the appended claims.

What is claimed is:

1. A voltage regulator comprising:
a regulating unit configured to generate a cell array operating voltage based on a power supply voltage and a reference voltage;
a power switch control unit configured to generate a power switch control signal based on a sensing enable signal; and
a power switch unit configured to compensate for a drop in the cell array operating voltage based on the power supply voltage and the power switch control signal, the cell array operating voltage dropping o when the sensing enable signal is activated.

2. The voltage regulator of claim 1, wherein
the power switch unit includes a first power switch and a second power switch,
the power switch control signal includes a first power switch control signal and a second power switch control signal, and
the first and second power switches are simultaneously turned on in response to the first and second power switch control signals and sequentially turned off in response to the first and second power switch control signals.

3. The voltage regulator of claim 2, wherein
the first and second power switch control signals are simultaneously activated based on the sensing enable signal,
the first power switch control signal is deactivated after a first delay time elapses from a first time at which the first power switch control signal is activated, and
the second power switch control signal is deactivated after a second delay time elapses from a second time at which the first power switch control signal is deactivated.

4. The voltage regulator of claim 2, wherein
the first power switch includes a first electrode receiving the power supply voltage, a gate electrode receiving the first power switch control signal and a second electrode connected to a cell array operating voltage supply line outputting the cell array operating voltage, and
the second power switch includes a first electrode receiving the power supply voltage, a gate electrode receiving the second power switch control signal and a second electrode connected to the cell array operating voltage supply line.

5. The voltage regulator of claim 1, wherein the regulating unit and the power switch unit are independently controlled.

6. The voltage regulator of claim 1, wherein the power switch control unit includes:
a pulse signal generating unit configured to generate a pulse signal in response to the sensing enable signal; and
a power switch control signal generating unit configured to generate the power switch control signal in response to the power supply voltage and the pulse signal.

7. The voltage regulator of claim 6, wherein the pulse signal generating unit includes:
a delay unit configured to delay the sensing enable signal; and
a NAND gate configured to generate the pulse signal by performing a NAND operation on the sensing enable signal and an output signal of the delay unit,

8. The voltage regulator of claim 6, wherein a pulse width of the pulse signal increases as a level of the power supply voltage is reduced.

9. The voltage regulator of claim 6, wherein
the power switch control signal includes a first power switch control signal and a second power switch control signal, and
the power switch control signal generating unit includes,
a first AND gate configured to generate the first power switch control signal by performing an AND operation on the pulse signal and the power supply voltage;
a delay unit configured to delay the first power switch control signal; and
a second AND gate configured to generate the second power switch control signal by performing the AND operation on the pulse signal and an output signal of the delay unit

10. The voltage regulator of claim 1, wherein the power switch control unit includes:
a power switch control signal generating unit configured to generate the power switch control signal based on the sensing enable signal and a gate control signal;
a comparator enabled in response to the sensing enable signal, the comparator configured to generate a comparison signal by comparing the cell array operating voltage with the reference voltage; and
a gate control signal generating unit configured to generate the gate control signal based on the sensing enable signal and the comparison signal.

11. The voltage regulator of claim 10, wherein
the power switch control signal includes a first power switch control signal and a second power switch control signal,
the gate control signal includes a first gate control signal and a second gate control signal, and
the power switch control signal generating unit includes,
a first AND gate configured to generate the first power switch control signal by performing an AND operation on the sensing enable signal and an inverted signal of the first gate control signal; and
a second AND gate configured to generate the second power switch control signal by performing the AND operation on the sensing enable signal and an inverted signal of the second gate control signal.

12. The voltage regulator of claim 11, wherein the gate control signal generating unit includes:
a first delay unit configured to delay the sensing enable signal;
a third AND gate configured to generate a first signal by performing the AND operation on the comparison signal and an output signal of the first delay unit;
a first flip-flop configured to generate the first gate control signal based on the power supply voltage and the first signal;
a second delay unit configured to delay the first gate control signal;
a fourth AND gate configured to generate a second signal by performing the AND operation on the first signal and an output signal of the second delay unit; and
a second flip-flop configured to generate the second gate control signal based on the power supply voltage and the second signal.

13. The voltage regulator of claim 11, wherein an activation period of the first power switch control signal or an activation period of the second power switch control signal is adaptively adjusted based on a level of the cell array operating voltage.

14. The voltage regulator of claim 1, wherein
the power switch unit includes a plurality of power switches that are divided into at least two power switch groups, and
the plurality of power switches are simultaneously turned on in response to the power switch control signal and sequentially turned off per power switch group in response to the power switch control signal.

15. A semiconductor memory device comprising:
a memory cell array including a plurality of memory cells, the memory cell array configured to operate based on a cell array operating voltage; and
a voltage regulator configured to generate the cell array operating voltage based on a power supply voltage, the voltage regulator including,
a regulating unit configured to generate the cell array operating voltage based on the power supply voltage and a reference voltage;
a power switch control unit configured to generate a power switch control signal based on a sensing enable signal; and
a power switch unit configured to compensate for a drop in the cell array operating voltage based on the power supply voltage and the power switch control signal, the cell array operating voltage dropping when the sensing enable signal is activated.

16. The voltage regulator of claim 14, wherein
power switches, from among the plurality of power switches, belonging to a first one of the at least two power switch groups is turned of before power switches, from among the plurality of power switches, belonging to a second one of the at least two power switch groups is turned off.

17. A voltage regulator, comprising:
a regulating circuit configured to generate a cell array operating voltage based on a power supply voltage and a reference voltage;
a power switch control circuit configured to generate at least one power switch control signal based on a sensing enable signal; and
a power switch circuit configured to,
generate a current based on the power supply voltage and the at least one power switch control signal, and
apply the current to a cell array operating voltage supply line outputting the generated cell array operating voltage.

18. The voltage regulator of claim 17, wherein the power switch control circuit is configured to,
activate the sensing enable signal,
generate a pulse signal based on the activated sensing enable signal,
activating a plurality of power switch control signals based on at least the generated pulse signal,
simultaneously activate a plurality of power switches in response to the activated plurality of power switch control signals, and
sequentially deactivate the plurality of power switches in response to deactivation of a corresponding one of the plurality of power switch control signals.

19. The voltage regulator of claim 18, wherein an amount of the generated current is based on a number of the plurality of power switches that are active at a given time.

20. The voltage regulator of claim 18, wherein the amount of the generated current is directly proportional to the of the plurality of power switches that are active at a given time.
